(19) United States
(12) Patent Application Publication
(10) Pub. No.: US 2004/0257743 A1
(43) Pub. Date: Dec. 23, 2004

(54) LAN magnetic interface circuit with passive ESD protection

(75) Inventors: John Chen, Danville, CA (US); Steve Contreras, Pleasanton, CA (US)

Correspondence Address: OSTROLENK FABER GERB & SOFFEN, 1180 AVENUE OF THE AMERICAS, NEW YORK, NY, 100368403

(73) Assignee: Bel-Fuse, Inc.

(21) Appl. No.: 10/871,247

(22) Filed: Jun. 18, 2004

Related U.S. Application Data
(60) Provisional application No. 60/480,584, filed on Jun. 19, 2003.

(51) Int. Cl. H02H 9/06

(52) U.S. Cl. 361/119

(57) ABSTRACT

A magnetic interface circuit for providing ESD protection for a communication channel which includes a capacitor connected between ground and a point in the circuit electrically isolated from the input and output terminals of the circuit. The capacitor is arranged such that the capacitor acts as a virtual ground to ESD events to shunt current from an ESD event to ground. The location of the capacitor enables the use of a low voltage capacitor, as well as eliminates the need for stringent Hi-pot and spacing requirements.

### CROSS-REFERENCE TO RELATED APPLICATIONS

This application is based on and claims the benefit of U.S. Provisional Application No. 60/480,584, filed Jun. 19, 2004, and entitled “LAN MAGNETICS INTERFACE CIRCUIT WITH PASSIVE ESD PROTECTION.”

### BACKGROUND OF THE INVENTION

The present invention relates generally to protecting telecommunications equipment against electrostatic discharge (ESD) events and, more particularly, to providing protection for LANs (local area networks), such as ETHERNET networks, against ESD events.

The input/output (I/O) ports of networking equipment and products (typically RJ45 connectors for Ethernet systems) are susceptible to ESD events, which can be in excess of 15 kilovolts. Two of the most common causes of ESD events are air discharge or contact discharge of an electrostatic charge, such as from a person, and/or when a “charged” data cable is plugged into the I/O connector. Such ESD events can corrupt the signals being transmitted and received, cause latch-up, or permanently damage the electronic circuitry. Moreover, the new generations of Power over Ethernet (PoE) products are particularly sensitive to ESD because the powered devices are commonly “floating” (have no earth ground). With no local return path for an ESD event occurring at the powered device, the ESD surge will traverse through the data cable conductors and be applied directly to the I/O pins of the network equipment. This is a major problem for PoE systems because the IEEE 802.3af protocol dictates that power to the port must be shutdown upon detection of a fault, thereby terminating the communication link between the powered device and the power sourcing equipment. This is unacceptable for most PoE applications and particularly for IP telephones where quality of service must be maintained as required by IEEE and other regulatory standards.

The most commonly used method of ESD protection for the I/O ports of electronic equipment is to incorporate active transient voltage suppression devices (TVS) such as clamping diodes, MOV's (metal oxide varistors), Sidactor® and various other types of active transient voltage suppression devices. A TVS is a bi-directional device that exhibits a high off-state impedance during normal operation. When the voltage across a TVS device exceeds its rated trigger voltage, the TVS rapidly switches into a very low impedance state and shunts the ESD transient to ground while clamping the voltage to a safe level, thereby protecting the sensitive electronic circuitry downstream. The TVS reverts back to an off-state once the transient event is over.

In the case of Ethernet equipment, these devices are placed on the line-side (cable-side) of the magnetic interface circuit. Typically, one TVS is connected between each of the data lines and chassis ground. Additional protection devices can also be required across the data lines to protect against differential (metallic) electrical transient surge events.

FIG. 1 shows a typical implementation of a magnetic interface circuit 10 using active transient suppression devices (TVS) 34 to provide ESD protection to a single channel of a PoE port. The magnetic interface circuit 10 includes line side terminals 12, circuit side terminals 14, an autotransformer 16, a CMC (common mode choke) 18 and an isolation transformer 20. A termination network 22 comprising a resistor 24 and a capacitor 26 is connected to the autotransformer 16 via a blocking capacitor 28. A DC bus 30 is provided for the PoE network. The high voltage capacitor 20 of the termination network 26 is shared with the other channels of the port (not shown) through connection 32. For non-PoE implementations, the DC blocking capacitor 28 is not required. TVS devices 34 are connected respectively to each of the terminals 12 of the line side of the magnetic interface circuit to protect against ESD events. Optionally, a TVS device 34 is connected across the terminals 12 to provide differential electrical surge protection.

Active transient suppression devices, such as the TVS devices 34, can be very effective in protecting sensitive electronic circuitry from ESD events. However, there are several major disadvantages associated with these devices. These disadvantages are particularly critical for integrated connector modules (ICM's)—a special type of LAN connector which has the magnetic interface circuit integrated inside the connector housing. One drawback of the ICM is that there is very little room inside for placing the transient suppression devices and the associated interconnecting wiring. Although the disadvantages described below are with reference to integrated connector module applications, they also apply to systems which utilize discrete magnetics interface circuits and discrete connectors.

1) The number of TVS devices required per port: To provide adequate surge protection, two or more TVS devices are required for each channel of an Ethernet I/O port. For 10/100 Mbps Ethernet, there are 2 channels (4 data lines) per port. Gigabit Ethernet utilizes 4 channels (8 data lines) per port. Hence, 4 to 6 TVS's are needed for each 10/100 port; 8 to 12 TVS's for each Gigabit port.

2) High cost: TVS devices are relatively expensive. This is very significant since each Ethernet port requires a minimum of 4 TVS devices for 10/100 and 8 TVS devices for gigabit. For the types of TVS device generally specified by the network equipment manufacturer the added cost of the TVS devices alone can approach, or even exceed the cost of the entire integrated connector module.

3) Hi-pot (high potential) safety requirement: Ethernet ports must comply with IEEE and other regulatory agency safety requirements including Hi-Pot. To provide effective ESD protection, the switching voltage of the line-to-ground TVSs should be well below the Hi-Pot test voltage. But in such case, the TVS devices will turn on during the Hi-Pot test and be damaged or destroyed. This means that the line-to-ground TVS devices would need to be removed from the circuit during the Hi-Pot test, which is not practical. If line-to-ground TVS devices with trigger voltages higher than the Hi-Pot test voltage are used, the effectiveness of the ESD protection would be minimal.

4) The safety spacing required: Since the TVS devices are on the line-side of the magnetic interface circuit, the devices and all interconnecting conductors must comply with safety spacing (clearance and creepage) requirements. In general, there must be adequate physical separation (typically 2 mm) between all exposed conductive points and ground. This includes the device terminals, the solder pads, and all exposed interconnecting wiring and PCB (printed circuit board) traces.

5) Large board area required: The TVS devices plus associated interconnecting wiring require a large amount of PCB area, particularly considering the number of devices required for each port and the hi-pot spacing requirements.

6) Limited flexibility and difficult to design-in: The number of devices required together with the safety spacing requirements makes it difficult, if not impossible, to implement this ESD protection scheme into existing designs. Implementation into new products will be a major design challenge resulting in longer development cycles.

7) Capacitive loading: The high parasitic capacitance of TVS devices will cause increased Return Loss and degrade signal integrity, particularly in 100 Mbps and Gigabit Ethernet systems.

As an alternative to using TVSs, ESD protection has been achieved by connecting a relatively high value capacitor 36 (e.g. 0.22 μF, 2 KV) to the center tap of the auto-transformer 16, as shown in the magnetic interface circuit 10A of FIG. 2. For magnetics interface circuit topologies that do not use an autotransformer, the capacitor 36 is connected to the line-side center-tap of the isolation transformer (not shown).

The capacitor 36 acts as a “virtual ground” to ESD events and shunts the ESD current to chassis ground. A relatively high value of capacitance is required in order to drastically reduce the rise time (dv/dt) of the ESD event, thereby preventing it from passing through the isolation transformer and degrading or destroying the sensitive transceiver IC. Because the capacitor is connected to the center-tap instead of the data lines, it does not significantly degrade the signal integrity.

Although the line-side passive ESD protection method depicted in FIG. 2 provides good immunity to ESD events, there are a number of disadvantages that precludes its use in the extremely cost sensitive, high circuit density networking systems. Most of the disadvantages are related to the fact that capacitor 36 must be able to withstand high voltage (2 kV, or higher) in order to meet various regulatory agencies safety (hi-pot) requirements. The major disadvantages are set forth below. Although the disadvantages described below are with reference to integrated connector module applications, they also apply to systems which utilize discrete connectors and magnetics.

1) High Cost: High voltage capacitors are expensive. Considering that one capacitor 36 is required for each data channel and that there are up to 4 channels per a single Ethernet port, the cost of the number of high voltage capacitors 36 required is unacceptably high.

2) Large Size: The physical size of a high voltage capacitor 36 of the required value is large. There is simply not enough room inside the connector module to accommodate multiple high voltage capacitors 36, particularly because the HV capacitors are on the line-side of the magnetics where there is very little room available.

3) Hi-Pot and safety requirements: In addition to the large size of high voltage capacitors 36, a substantial amount of additional area is required for the solder pads and interconnecting wiring plus the area needed to maintain adequate creepage and clearance spacing.

4) Limited flexibility; difficult to design-in: The large size of the high voltage capacitors together with the safety spacing requirements makes it difficult, if not impossible, to implement this ESD protection scheme into existing designs. Implementation into new products will be a major design challenge resulting in long development times.

5) System performance problems: The ESD protection capacitor 36 of FIG. 2 replaces the RC termination network 36 of FIG. 1 normally used to provide proper pair-to-pair impedance and common-mode noise termination. This has the potential to cause crosstalk, long haul data integrity, and EMI emissions/susceptibility problems.

6) Stored charge: The ESD protection capacitor 36 can acquire and sustain a charge, particularly in non-PoE circuit configurations where there is no discharge path for the capacitor.

### SUMMARY OF THE INVENTION

It is an object of the present invention to provide a new magnetics interface circuit topologies which overcomes most if not all of the disadvantages associated with the prior art protection schemes. In accordance with certain features of the invention, this and other objects are effected by placing the ESD protection capacitor at an isolated point within the magnetics interface circuit. This will remove all of the restrictions associated with hi-pot and safety spacing and has additional advantages as well

Other features and advantages of the present invention will become apparent from the following description of the invention which refers to the accompanying drawings.

### BRIEF DESCRIPTION OF THE DRAWING(S)

FIG. 1 shows schematically a prior art implementation of a PoE Ethernet LAN magnetic interface circuit with ESD protection, using TVSs.

FIG. 2 shows schematically a prior art implementation of a PoE Ethernet LAN magnetic interface circuit with ESD protection, using a high voltage capacitor.

FIG. 3 shows schematically ESD protection of a magnetic interface circuit connected to a PoE Ethernet LAN port in accordance with certain principles of the present invention.

FIG. 4 shows schematically an alternative embodiment of ESD protection of a magnetic interface circuit connected to a PoE Ethernet LAN port in accordance with certain principles of the present invention.

### DETAILED DESCRIPTION OF PREFERRED EMBODIMENTS OF THE INVENTION

The invention will be described in connection with its applicability to provide ESD protection of PoE Ethernet applications; however, the invention is not so limited and is equally applicable to standard Ethernet and other networking applications.

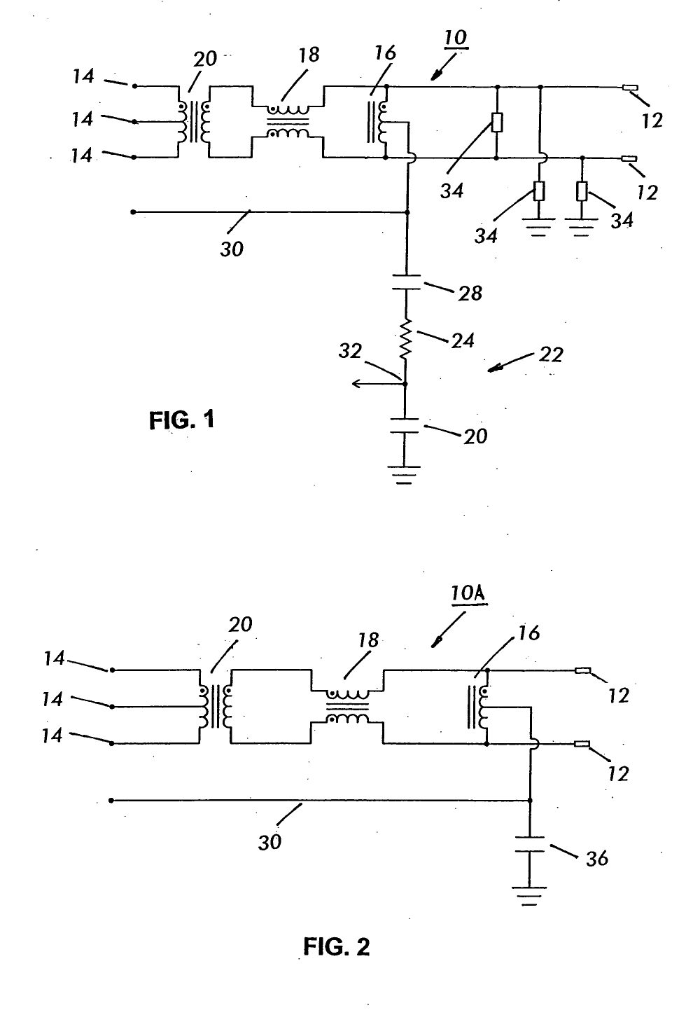

Components having the same or similar function to components in FIGS. 1 and 2 are designated with the same reference numerals.

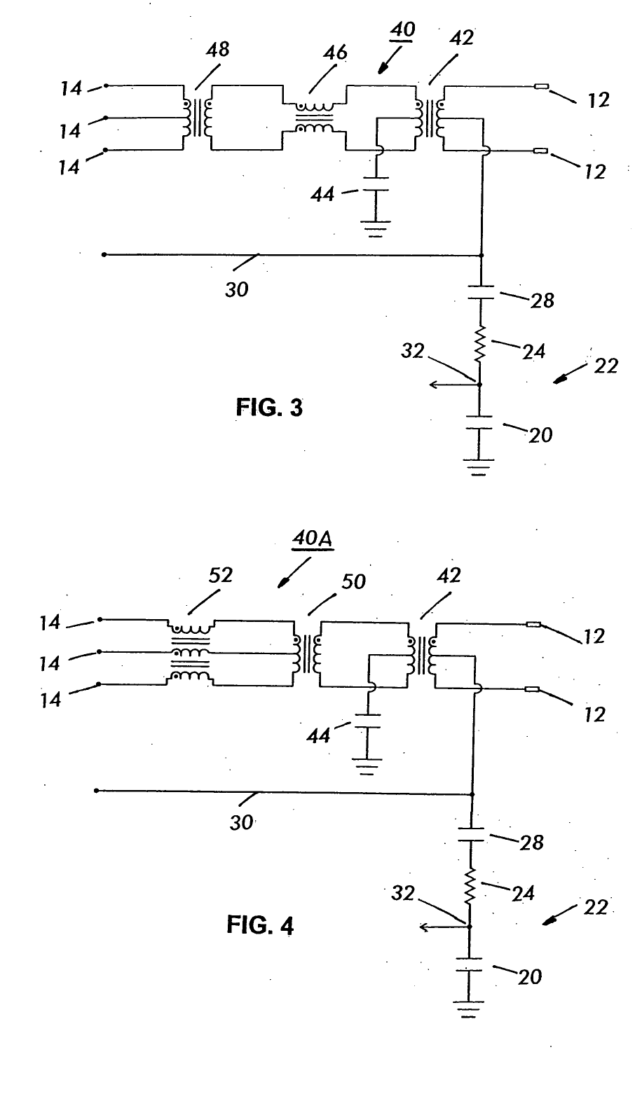

FIGS. 3 and 4 show two forms of a PoE magnetic interface circuits 40 and 40A using isolated passive ESD protection illustrating certain features of the present invention. In both FIGS. 3 and 4, the auto transformer 16 used in FIGS. 1 and 2 is replaced with an isolation transformer 42 and a relatively high value capacitor 44 is connected to the primary-side center tap of the transformer 42 and chassis ground. Illustratively, the capacitor 44 may be 0.22 μF and have a breakdown voltage rating of 50V. In FIG. 3, the isolation transformer is connected to a CMC 46 which, in turn, is connected to an isolation transformer 48 connected to the circuit side terminals 14; in FIG. 4, the isolation transformer 42 is connected to an isolation transformer 50 which, in turn, is connected to a 3-wire CMC 52 connected to the circuit side terminals 14.

In both FIGS. 3 and 4, the capacitor 44 functions in much the same way as the capacitor 36 of FIG. 2 to provide effective ESD protection. Thus, the capacitor 44 acts as a “virtual ground” to ESD events and shunts the ESD current to chassis ground. Placing the ESD protection capacitor 44 at an isolated point within the magnetics interface circuit removes all of the restrictions associated with hi-pot and safety spacing and has additional advantages as well.

1) Very low cost: The ESD protection capacitor 44 is a low voltage (e.g. 50v), garden variety capacitor which is very inexpensive. The additional cost of the isolation transformer 42 is minimal since it basically amounts to adding another winding on the ferrite core of the BST auto-transformer that is otherwise used in the standard magnetic interface circuit of FIGS. 1 and 2.

2) Small size: Low voltage capacitors 44 are much smaller in size than a high voltage capacitors of the same value, such as the capacitor 36 of FIG. 2.

3) No Hi-pot or spacing issues: Since the capacitor 44 is isolated from the line, there are no hi-pot or creepage/clearance spacing requirements for the capacitor 44 or the interconnecting wiring of the capacitor 44.

4) Greater design flexibility: Since the ESD protection capacitor 44 is small in size compared to that of a high voltage capacitor 36 and there are no safety spacing restrictions, placement and wiring of the capacitor 44 is greatly simplified. Hence, implementation of this ESD protection scheme into existing and new designs is not a major design challenge and will not significantly increase time-to-market.

5) No capacitive loading effect: The capacitor 44 does not significantly affect return loss or degrade signal integrity.

6) Allows use of an RC termination network: Since the ESD protection capacitor is not on the line-side, the line-side center tap is available for connection of an RC termination network 22 to provide proper channel-to-channel impedance matching and common-mode noise termination.

7) Adaptable: This form of ESD protection can be implemented into a host of different magnetic interface circuit topologies.

As should be appreciated from the foregoing, the present invention provides ESD protection for the I/O ports of Ethernet networking equipment using low-cost passive components and has many benefits over the prior art ESD protection schemes.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A magnetic interface circuit for providing ESD protection for a communication channel, which magnetic interface circuit comprises:
a first interface connectable to a line side of the channel;
a second interface connectable to a circuit side of the channel; and
a capacitor connected between ground and a point in the circuit electrically isolated from the first and second interfaces and arranged such that the capacitor acts as a virtual ground to ESD events to shunt current from an ESD event to ground.

2. A magnetic interface circuit for providing ESD protection for a communication channel, which magnetic interface circuit comprises:
an isolation transformer having a center tapped first winding connectable to a line side of the channel and a center tapped second winding;
a capacitor connected between the center tap of the second winding and ground and arranged such that the capacitor acts as a virtual ground to ESD events to shunt current from an ESD event to ground.

3. A magnetic interface circuit according to claim 2, wherein the center tap of the first winding is connectable to a DC power source.

4. A magnetic interface circuit for a Power over Ethernet port having a line side and a circuit side, which magnetic interface circuit comprises:
first and second isolation transformers having respective first and second windings, the first winding of the first isolation transformer being connectable to a line side of the port and the second winding of the first isolation transformer being connected to the first winding of the second isolation transformer, each of the first and second windings of the first isolation transformer having center tap connections; and the second winding of the second isolation transformer being connectable to a circuit side of the port; and
a capacitor connected between the center tap of the second winding of the first isolation transformer and ground and arranged such that the capacitor acts as a virtual ground to ESD events to shunt current from an ESD event to ground, the center tap of the first winding of the first isolation transformer beings connectable to a DC power source.

5. A magnetic interface circuit according to claim 4, wherein the second winding of the first isolation transformer is directly connected to the first winding of the second isolation transformer.

6. A magnetic interface circuit according to claim 5, wherein the second winding of the second isolation transformer is connectable to the circuit side of the port via a common mode choke.

7. A magnetic interface circuit according to claim 4, wherein the second winding of the first isolation transformer is connected to the first winding of the second isolation transformer via a common mode choke.

8. A magnetic interface circuit according to claim 7, wherein the second winding of the second isolation transformer is directly connectable to the circuit side of the port.
